(19) United States
(12) Patent Application Publication
(10) Pub. No.: US 2023/0389564 A1
(43) Pub. Date: Dec. 7, 2023

(54) ULTRAVIOLET TREATMENT OF COLEOPTERA LARVAE OIL FOR VITAMIN D3 ENRICHMENT

(71) Applicant: NUTRI'EARTH, Lomme (FR)

(72) Inventors: Jérémy DEFRIZE, Hallennes les Haubourdin (FR); Thomas DORMIGNY, Meurchin (FR); Charles-Antoine DESTAILLEUR, Sailly sur La Lys (FR)

(21) Appl. No.: 18/249,129

(22) PCT Filed: Oct. 13, 2021
(86) PCT No.: PCT/FR2021/051784

§ 371 Date: Apr. 14, 2023

(30) Foreign Application Priority Data
Oct. 16, 2020 (FR) 2010673
Feb. 8, 2021 (FR) 2101193

(51) Int. Cl. A23D 9/04; A23L 5/30; A23L 33/115; A23K 20/158; A23L 5/20; A23L 5/10

(52) U.S. Cl. CPC A23D 9/04; A23L 5/30; A23L 33/115; A23K 20/158; A23L 5/23; A23L 5/13

(57) ABSTRACT

The present invention relates to a method for the preparation of a coleoptera oil enriched with vitamin D3 including a light treatment step in which at least one light source emits ultraviolet rays in the direction of said coleoptera oil.

### TECHNICAL FIELD

The present invention relates to the food industry sector.

The object of the present invention relates more particularly to the preparation of an oil or oil fraction rich in vitamin D3 from fresh coleoptera larvae or coleoptera powder.

One of the objects of the present invention is the enrichment with vitamin D3 of an oil or oil fraction extracted from fresh larvae or coleoptera powder.

The present invention thus has many applications particularly in the food industry, and in particular for human food or animal food (pet food/pet care/food supplements).

### PRIOR ART

Vitamin D3 has important properties for the body.

Vitamin D3 is defined here as cholecalciferol.

In humans, this vitamin D3 helps to maintain normal levels of calcium and phosphorus in the blood. It strengthens the immune system and improves cognitive function.

Vitamin D3 also has an essential role in maintaining the skeletal muscles and bones in humans and pets such as dogs.

It is used for example as a calcium supplement to prevent osteoporosis in the elderly.

In reptiles, vitamin D3 allows an optimal assimilation of calcium and mineralisation of bones.

In humans, it is currently known that 50% of adults in good health are suffering from a deficiency in vitamin D3.

The daily requirement of vitamin D3 is 15 μg for adults and can rise to 20 μg in those over 70 years of age.

Traditionally, foods containing vitamin D3 come essentially from fish, particularly from fish oils, fillets and livers. However, fish are a resource that is declining and are thus becoming more and more expensive.

There are also supplements of vitamin D3 that are extracted from boreal lichen or synthesised from lanolin.

However, the demand for vitamin D3 is increasing; the Applicant submits that the existing solutions are expensive and cannot meet this demand.

Stakeholders in the food industry are currently investing a lot of energy in finding solutions for providing vitamin D3 in a sustainable and reasonable manner.

The use of coleoptera larvae is well known in the food industry.

Such larvae can contain between 15 and 35% fat by weight in dry matter. The fat extracted from these larvae in the form of oil can therefore be used to meet food requirements.

However, naturally, coleoptera oil contains little or no vitamin D3.

The Applicant submits that there is currently no technology for enriching a coleoptera oil with vitamin D3.

### Summary and Object of the Present Invention

The present invention aims to improve the situation described above.

The present invention relates more particularly to overcoming the various disadvantages mentioned above by proposing a solution for enriching a coleoptera oil with vitamin D3, such an oil having to be consumable as a food or food supplement for humans or other farmed or pet animal species.

To this end, the object of the present relates according to a first aspect to a method for preparing a coleoptera oil enriched with vitamin D3 comprising a light treatment step during which at least one light source emits ultraviolet rays in the direction of said coleoptera oil.

The Applicant observes that the results obtained by the UV treatment on the coleoptera oil are very favourable and show an enrichment in vitamin D3 of the coleoptera oil. Such a UV treatment makes it possible to generate an oil ten to twelve times richer in vitamin D3 than cod liver oil, considered to be the richest oil in vitamin D3 (250 μg/100 g, source: CIQUAL, Anses).

It should also be noted that the oil obtained by this method is not rancid; it has an acceptable oxidation rate (a peroxide index of below 5 meqO2/kg fat, p-anisidine of below 3 and a TOTOX index of below 26). Such an oxidation rate is a quality indicator for consumption. With the above indexes, it is understood that the oil obtained by the method is consumable by humans or other farmed or pet animal species.

Advantageously, the method according to the present invention includes a preliminary phase of extraction of a coleoptera oil comprising:
a lipid fraction (or oil fraction) comprising lipids extracted preferably from either fresh live larvae, fresh frozen larvae, larvae that have been boiled between 50 and 120° C. for at least 5 seconds, or dehydrated and/or powder reduced coleoptera larvae; or
any lipid sub-fraction (or sub-oil fraction) extracted from this said oil fraction.

Preferably, the fraction and/or sub-oil fraction comprises lipids of the sterol class.

Lipids are defined as any molecules belonging to the following classes: fatty acid class, acylglycerol class, phosphoacylglycerol class, sterol class, sphingolipid class, polyketide class, phenol class and saccharolipid classes.

Fresh larvae are defined as coleoptera larvae containing at least 50% water.

Coleoptera powder is defined as coleoptera larvae containing less than 10% water.

This extraction phase comprises one or more steps which make is possible to obtain an oil having physicochemical characteristics which allow their use in human or animal food as a food ingredient or supplement.

Advantageously, the extraction phase comprises a step of hot or cold mechanical pressing of said coleoptera larvae.

Advantageously, the extraction phase comprises at least one centrifugation step. Said centrifugation step is preferably performed on the larvae once crushed and/or pressed.

Such centrifugation facilitates the oil recovery and extraction operation.

Optionally, the extraction phase comprises a step of adding a solvent to promote the extraction.

Preferably, the added solvent is selected from the following solvents: ethanol, water.

Advantageously, the at least one light source has a radiation power of between 13 and 125 Watts, preferably between 20 and 50 Watts.

Advantageously, the treatment step is performed continuously or discontinuously for a total treatment period of between 1 minute and 8 hours, preferably between 10 minutes and 90 minutes.

Such a period of treatment of the oil shows an optimisation of the vitamin D3 synthesis. It is observed that UV rays and oxygen act as an oxidation factor of the fatty acids which limits the exposure time of the oil.

Advantageously, the coleoptera oil is placed during the treatment step in a receptacle and has a depth relative to the bottom of said receptacle of between 1 and 50 mm, preferably between 3 and 10 mm.

In other words, the oil layer has a height of between 1 and 50 mm, preferably between 3 and 10 mm.

Such a depth (or height) makes the UV treatment effective as the rays can pass through the entire oil layer to improve the performance of the vitamin D3 synthesis.

Advantageously, the coleoptera oil is maintained in an environment with a substantially constant temperature of between 15 and 30° C., preferably between 21 and 24° C.

The Applicant observes here that the synthesis of vitamin D3 is optimised in the presence of a temperature above 20° C. However, the heat is a factor in the oxidation of fatty acids limiting the temperature range during the light treatment.

Advantageously, the ultraviolet rays emitted by the at least one light source are of the UVB type and consist of electromagnetic radiation with a wavelength of between 280 nm and 320 nm.

Such rays in the UV and especially UVB wavelengths allow the activation and acceleration of the synthesis of vitamin D3.

Such properties are known in humans and certain reptiles in particular. However, these properties have never been observed or exploited with coleoptera oil.

It should be noted here that the amount of vitamin D3 synthesised is dependent on the amount of UVB received per unit of time.

Preferably, it is envisaged that, during the light treatment step, the at least one light source is positioned at a defined distance from the coleoptera oil of between the order of 1 to 100 centimetres, preferably between the order of 5 to 20 centimetres.

Preferably, the intensity of the UV light sources decreases as one moves away from it.

Preferably, the coleoptera are selected from the following: Tenebrio molitor and/or Alphitobius diaperinus and/or Tribolium castaneum.

The object of the present invention relates, according to second aspect, to a coleoptera oil obtained by the implementation of a preparation method as described above, said oil comprising at least 300 μg vitamin D3 for 100 grams of oil.

The object of the present invention relates, according to a third aspect, to a food supplement including a coleoptera oil as described above for human or animal food.

Alternatively, the object of the present invention relates, according to a fourth aspect, to an ingredient including a coleoptera oil as described above for human or animal food.

By way of the various technical features above, and in particular an ultraviolet light treatment of the coleoptera oil, the present invention makes it possible to obtain a coleoptera oil containing a much higher percentage of vitamin D3 than the coleoptera oil which has not undergone UV treatment, with an acceptable oxidation rate (for example with a peroxide index of less than 5 meq O2/kg fat, anisidine index of less than 3 and TOTOX index of below 26), while still being industrialisable.

### FIGURES

Further features and advantages of the present invention are given in the following description, with reference to the attached FIGS. 1 and 2 which illustrate a non-limiting example of the invention and in which:

FIG. 1 is a graph showing the enrichment of the coleoptera oil in relation to cod liver oil as a function of the duration of the light treatment.

FIG. 2 is a chart showing the oxidation rate (peroxide index and anisidine index) of the coleoptera oil that has been enriched with vitamin D3 as a function of the treatment time.

### DETAILED DESCRIPTION

The following description is a provided as a simple illustration of the invention which is not limited in any way.

For the record, the invention described below is aimed at developing a technique for significantly increasing the level of vitamin D3 in the coleoptera oil.

For the sake of clarity and concision, the following species are given as coleoptera in the following description: Tenebrio molitor and/or Alphitobius diaperinus and/or Tribolium castaneum.

The person skilled in the art will understand here that the use of other species of coleoptera than the above species is possible within the scope of the present invention without departing from the present invention.

The Applicant submits that nothing in the prior art or even in the general knowledge of the person skilled in the art made it possible to envisage that it was possible to enrich coleoptera oil to such a level by UVB treatment.

In the example described here, a method for enriching coleoptera oil is provided comprising a light treatment step in which at least one light source emits ultraviolet rays in the direction of the coleoptera oil.

In other words, coleoptera oil is defined as:
the oil fraction comprising all lipids extracted preferably from either fresh live larvae, fresh frozen larvae, larvae that have been boiled at between 50 and 120° C. for at least 5 seconds, or dehydrated and/or powder reduced coleoptera larvae; and/or
any lipid sub-fraction extracted from this oil fraction, preferably a sub-oil fraction comprising lipids of the sterol class.

Extraction is defined as any extraction process which allows an oil to be obtained which has physicochemical characteristics which allow it to be used in human or animal food as a food ingredient or supplement.

The extraction process may involve a hot or cold mechanical pressing step.

The extraction process may involve one or more centrifugation steps.

The extraction process may involve the use of solvents.

It should be noted here that the extraction phase of the oil fraction is not described in detail in this document, as the invention relates mainly to the enrichment of the oil or the oil fraction obtained by UV treatment.

Fresh larvae are defined as coleoptera larvae containing at least 50% water.

Coleoptera powder is defined as coleoptera larvae containing less than 10% water.

In this example, the ultraviolet rays emitted by the at least one light source in the direction of the coleoptera oil during the light treatment step are of the UVB type and consist of electromagnetic radiation with a wavelength of between 280 nm and 320 nm.

The light rays in the UV and especially UVB wavelengths are known to trigger the synthesis of vitamin D3 in humans and certain reptiles.

In this example, it is envisaged, during the light treatment step, that the at least one light source is positioned at a determined distance from the coleoptera oil of between the order of 1 to 100 centimetres, preferably between the order of 5 to 20 centimetres.

The intensity of the UV light sources decreases as one moves away from it. The quantity of vitamin D3 synthesised is dependent on the amount of UVB received per unit of time.

In this example, at least one light source has a radiation power of between 13 and 125 Watts, preferably between 20 and 50 Watts.

Advantageously, it is envisaged that, during the light treatment step, the at least one light source emits ultraviolet rays in the direction of the coleoptera oil in treatment ranges of between 10 minutes and 8 hours continuously, preferably between 1 and 4 hours. UV and oxygen are known to be a factor in the oxidation of fatty acids which limits the exposure time of the oil.

In this example, it is envisaged that, during all or part of the light treatment step, the coleoptera oil is maintained in an environment with a substantially constant temperature of between 20 and 30° C., preferably between 21 and 24° C.

The synthesis of vitamin D3 is optimised in the presence of a temperature above 20° C. However, the heat is a factor in the oxidation of fatty acids limiting the temperature range during the light treatment.

The Applicant submits that the present invention allows an enrichment with vitamin D3 of the coleoptera oil.

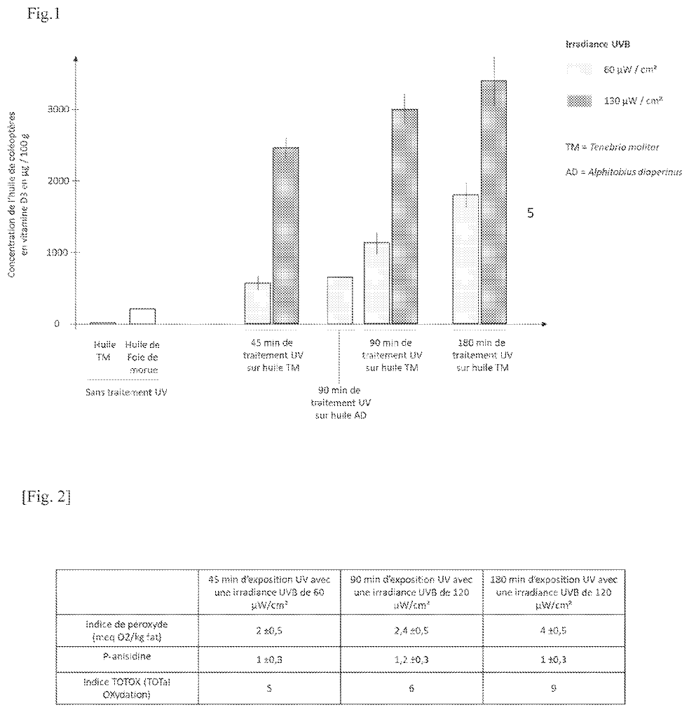

The tests carried out in this example and the results shown in FIG. 1 demonstrate the importance of the exposure time and UV radiation level on the concentration of vitamin D3 in the coleoptera oil.

We have plotted in FIG. 1 the concentration of vitamin D3 in a coleoptera oil without UV treatment. The observed values are between 0 and 1 μg/100 g. We have also indicated in FIG. 1 the average concentration of vitamin D3 in cod liver oil, i.e. 250 μg/100 g (source: CIQUAL, Anses).

We then measured the concentration of vitamin D3 in the oil from coleoptera larvae (Tenebrio molitor, TM or Alphitobius diaperinus, AD) over three distinct UV exposure times (45, 90 and 180 minutes) and at two radiation levels (60 and 120 μW/cm²). The oil samples are placed 20 cm from the UV light source on a layer with a thickness of 5 mm±1 mm in stainless steel containers with dimensions 50×30×5 cm.

The UV source with an average UVB radiation of 60 μW/cm² in the container at the level of oil is emitted from a 25 W UVB bulb.

The UV source with an average UVB radiation of 120 μW/cm² in the container at the level of the oil is emitted from a 18 W T8 UVB light.

The two sources have a peak emission of between 310 and 320 nm.

It is firstly observed that it is possible to achieve high levels of vitamin D3 (<3000 μg/100 g) from 90 minutes of exposure with a radiation level of 120 μW/cm² by the method described in the present invention.

The Applicant submits that the levels obtained here with these tests could not have been anticipated by the person skilled in the art.

It is further noted that the exposure time and the radiation level have a positive impact on the concentration of vitamin D3.

Analyses of the concentration of vitamin D3 were carried out on each of the samples by a COFRAC-certified analysis laboratory. For each duration of treatment, N=2 except for the concentration of vitamin D3 on Alphitobius diaperinus oil (N=1).

The Applicant also tested (FIG. 2) the impact of a significant increase in UVB radiation and exposure time on the oxidation of the coleoptera oil. As mentioned above, this oxidation is an indicator of the quality for consumption.

In these tests, several oxidation indicators were measured such as:
the peroxide index (PI). This index makes it possible to evaluate the degree of oxidation of unsaturated fatty acids in the fat. This index is an indicator of the start of oxidation. Peroxides are formed from free radicals that are created in the initiation phase of the oxidation reaction.
The anisidine index (AI). This index corresponds to the measurement of the secondary oxidation products of fats. This index measures the quantity of aldehydes (mainly α, β-unsaturated aldehydes).
The TOTOX (TOTal OXidation) index which is a measurement of the oxidation of the oil from the peroxide index and the anisidine index. TOTOX index=(2×IP)+IA. A product is considered to be harmful if the TOTOX index is greater than 26.

The oxidation analyses were carried out at a COFRAC certified laboratory. The oxidation analyses were performed on Tenebrio molitor oil.

Analyses of the peroxide and anisidine indexes on UV-treated coleoptera oil show acceptable levels of oxidation at 180 minutes of exposure and an irradiance of 120 μW/cm² as a TOTOX value of 9 is obtained. If the exposure time (45 and 90 min) and/or the irradiance level (60 μW/cm²) is reduced, the oxidation values, in particular the peroxide index and the TOTOX value, also decrease.

By way of comparison, for the peroxide index, according to the STAN 33-1981 codex, the maximum value is 20 for virgin olive oil and 5 for refined olive oil. The TOTOX (TOTal OXidation) index represents the oxidation state by aggregating the results of the two measurements (TOTOX index=2×peroxide index+anisidine index). Quality oils generally have a TOTOX value of below 10.

It is commonly accepted that the value of this TOTOX index for an oil should be less than 26. The TOTOX index obtained after the treatment of the present invention shows values which are well below this threshold value, which makes the oil obtained by the method perfectly consumable.

All of these results make it possible to easily envisage a reliable and profitable industrialisation of the UV treatment method on coleoptera oil.

It should be observed that this detailed description relates to a particular embodiment of the present invention, but this description does not have any limiting effect on the object of the invention; on the contrary, it has the objective of removing any possible imprecision or any misinterpretation of the claims that follow.

It should also be noted that the reference signs in brackets in the claims that follow are in no way limiting; these signs are intended solely to improve the intelligibility and understanding of the following claims and the scope of the protection sought.

1. A method the preparation of a coleoptera oil enriched with vitamin D3 comprising a light treatment during which at least one light source emits ultraviolet radiation in the direction of said coleoptera oil.

2. The Method according to claim 1, further comprising a preliminary phase of extracting a coleoptera oil during which:
an oil fraction; and/or
a sub-oil fraction is extracted from said oil fraction,
by subjecting the oil fraction and/or sub-oil fraction to the light treatment during which at least one light source emits ultraviolet rays in the direction of said coleoptera oil.

3. The method according to claim 2, wherein said fraction and/or sub-oil fraction comprises lipids from the sterol class.

4. The method according to claim 2 or 3, wherein said oil fraction and/or sub-oil fraction comprises lipids extracted from at least one selected from a group consisting of:
fresh live larvae;
fresh frozen larvae;
larvae which have previously been subjected to boiling at between 50 and 120° C. for a minimum 5 of seconds; and
dehydrated and/or powder reduced coleoptera larvae.

5. The method according to claim 2, wherein the extraction phase comprises a hot or cold mechanical pressing of said coleoptera larvae.

6. The method according to claim 2, wherein the extraction phase comprises at least one centrifugation step.

7. The method according to claim 2, wherein the extraction phase comprises adding a solvent to promote the extraction.

8. The method according to claim 7, wherein said added solvent is one selected from the group consisting of ethanol and water.

9. The method according to claim 1, wherein said at least one light source has a radiation power of between 13 and 125 Watts, preferably between 20 and 50 Watts.

10. The method according to claim 1, wherein the ultraviolet rays emitted by said at least one light source have a light intensity which decreases as one moves away from it.

11. The method according to a claim 1, further comprising a treatment performed continuously or discontinuously for a total treatment time of between 1 minute and 8 hours, preferably between 10 and 90 minutes.

12. The method according to 11, wherein the coleoptera oil is placed during the treatment step in a receptacle and has a depth relative to the base of said receptacle of between 1 and 50 mm, preferably between 3 and 10 mm.

13. The method according to claim 1, wherein the coleoptera oil is maintained in an environment with a substantially constant temperature of between 15 and 30° C., preferably between 21 and 24° C.

14. The method according to claim 1, wherein said ultraviolet rays emitted by the at least one light source are of the UVA and/or UVB and/or UVC type and consist of electromagnetic radiation with a wavelength of between 200 nm and 380 nm, preferably between 280 and 320 nm.

15. The method according to claim 1, wherein said at least one light source is positioned at a defined distance from the coleoptera oil of between 1 and 100 centimeters, preferably between 5 and 20 centimeters.

16. The method to according to claim 1, wherein the coleoptera is at least one selected from the group consisting of: Tenebrio molitor, Alphitobius diaperinus and Tribolium castaneum.

16. A coleoptera oil obtained by the implementation of a method of preparation according to claim 1, said oil comprising at least 300 μg vitamin D3 for 100 grams of oil.

17. A food supplement including a coleoptera oil according to claim 16 for human or animal consumption.

18. An including a coleoptera oil according to claim 16 for human or animal consumption.
